(19) United States
(12) Patent Application Publication
(10) Pub. No.: US 2020/0019767 A1
(43) Pub. Date: Jan. 16, 2020

(54) DOCUMENT CLASSIFICATION SYSTEM

(71) Applicant: KnowledgeLake, Inc., St. Louis, MO (US)

(72) Inventors: Bradley Porter, St. Louis, MO (US); Kyle Flanigan, St. Louis, MO (US); Ryan Braun, St. Louis, MO (US); Timothy Karleskint, St. Louis, MO (US); Nicholas Heembrock, St. Louis, MO (US); Jason Burian, St. Louis, MO (US)

(73) Assignee: KnowledgeLake, Inc., St. Louis, MO (US)

(21) Appl. No.: 16/510,356

(22) Filed: Jul. 12, 2019

Related U.S. Application Data
(60) Provisional application No. 62/696,994, filed on Jul. 12, 2018.

(51) Int. Cl. G06K 9/00; G06N 3/08; G06K 9/62; G06Q 30/04

(52) U.S. Cl. CPC G06K 9/00442; G06Q 30/04; G06K 9/6256; G06N 3/08

(57) ABSTRACT

A document classification system and method for classifying documents includes providing a set of electronic documents to be classified. The documents may be compared to templates of known documents, run through a neural network that is trained to determine common features within a classification, or analyzed as a vector to similar vectors of classified documents to determine appropriate classification. The classification may include parameters defined to extract data from the document, such as anchor objects that define a location relative to the anchor where known data may be extracted. The extracted data may be associated with the classified document.

### CROSS-REFERENCE TO RELATED APPLICATION

This application claims priority to U.S. Provisional Patent Application No. 62/696,994 filed on Jul. 12, 2018 and entitled DOCUMENT CLASSIFICATION SYSTEM, which is hereby incorporated by reference.

### FIELD OF INVENTION

The present invention relates to the field of document classification and specifically to a system and method for classifying electronic documents and creating or utilizing templates for classifying documents.

### BACKGROUND

In recent years, electronic communications have replaced physical documents for many business correspondence, from letters to invoices and the like. Even physical documents sent by businesses are commonly scanned in and converted to digital or electronic documents. For most companies, managing and reading business documents and correspondence involves managing, sorting, and reading these electronic documents.

When various types of electronic documents are received by a company, staffers in the company have to read the contents at least once in order to receive and pass along necessary data and information. For example, when companies receive invoices, information on the invoices such as the company who the invoice is from, the invoice number, and the total amount owed, must be extracted from the documents and entered into the company's system to process the invoice and allow the invoice to be paid. Likewise, other documents must be similarly processed and entered into the company's systems.

In recent years, new systems have been developed to assist with extracting information from electronic documents. Tools such as Optical Character Recognition (“OCR”) and other similar tools allow characters on non-text or image documents to be read and converted over to machine-readable characters. These tools have enabled new systems and methods that allow for automated data extraction from electronic forms and documents that businesses receive, eliminating the need for human review of each document. However, automated data extraction commonly requires that a system first be taught parameters of the examined document, such as locations where data may be found, the type of data that is being extracted from each location, and what should be done with the extracted data. Often this is done by creating a template for a given document type that defines the data locations and rules for examining the document and extracting data.

In order for information to be extracted from documents, the documents must first be sorted and assigned to an appropriate template. The template will define what zones will be analyzed and what data will be extracted from each zone of the document. Current systems and methods require that documents be manually sorted. This step slows down the process and in some cases leads to backlogs of documents to be sorted.

Accordingly, an improved document classification system and method are needed.

### SUMMARY

A method of classifying documents is generally provided. The method comprises providing one or more electronic documents to be sorted and classified, each including data to be extracted. An electronic document from the one or more electronic documents is compared to a template having one or more objects, wherein the objects are compared to the electronic document. The template includes parameters that define data to be extracted from the document that matches the template. A match between the electronic document and the template is determined based on the presence of one or more template objects in the electronic document. Data is then extracted from the electronic document based on the template parameters. The data is associated with the electronic document, such as in metadata of the electronic document.

In an embodiment, the object may include one or both of a graphic image or a text to be found on the electronic document. The graphic image may include a company logo or image related to a business or company.

In an embodiment, the template parameters include an anchor object and a predefined location of a data to be extracted from the electronic document based on the location of the anchor object on the electronic document. The method may include determining the location of the anchor object on the electronic document and locating the data to be extracted from the electronic document based on the location of the anchor in the electronic document.

In an embodiment, a method of classifying electronic documents includes training a neural network to determine common features within a document classification. The training steps may include (1) analyzing a set of electronic documents within a common classification; and (2) determining common features between the set of electronic documents within the common classification. The method of classifying electronic documents further includes the steps of: providing one or more electronic documents to be sorted and classified, the one or more electronic documents each including data to be extracted; comparing an electronic document from the one or more electronic documents to the common features within a given classification; determining a match between the electronic document and the classification based on similarities between the electronic document and the common features; extracting data from the electronic document based on parameters associated with the classification; and associating the extracted data with the electronic document.

In an embodiment, the method of classifying a document using a neural network may include determining a vector value for an unclassified document. The vector may comprise a series of floating values related to attributes of the unclassified document. The unclassified document vector may be compared with similar vectors of documents within a given classification. A threshold comparison value may be used to determine if a match exists between the unclassified documents and the documents within the classification.

### BRIEF DESCRIPTION OF THE DRAWINGS

The operation of the invention may be better understood by reference to the detailed description taken in connection with the following illustrations, wherein:

FIG. 1 illustrates an electronic document to be processed by a data capture system or method;

FIG. 2 illustrates a plurality of OCR zones and anchors on an electronic document to be processed by a data capture system;

FIG. 3 illustrates a flow chart for an electronic document as processed by a document classification system and method and a data capture system and method; and

FIG. 4 illustrates a flow chart for automated creation of a template used in a document classification system and method.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A document classification system and method are generally presented. The document classification system and method may be configured to analyze electronic documents and classify them in order to extract certain data from the document. As used herein, the term “electronic documents” may comprise any digital or electronic document or file, and specifically may include any type of image file, such as a .pdf, .jpg, .tiff, .gif, .bmp, or any similar type of image or data file that includes a document.

It will be appreciated that the method described herein may implemented on a computer system. The system may include a central processing unit (“CPU”), a graphics processing unit (“GPU”), a storage device such as a hard drive, a memory, and capabilities to receive digital media, such as through a network connection, card reader, or the like. The system may receive electronic media and documents to be processed and may store the documents in a queue until they are classified and processed, as described herein.

The system and method described herein may be used in conjunction with a data capture system and method. The data capture method may generally be configured to read and extract specified data from electronic documents, including image files. To capture the desired data, each document may be classified and assigned a set of predetermined rules and parameters that define where certain data is located on the document and what each portion of extracted data represents. For example, documents classified as invoices for Company X may include rules that define an invoice amount located in a given region of a document. The capture system may apply OCR or other similar methods to the defined region to convert image data to readable text and capture the target data. The data may then be stored as directed by the electronic document's classification rules, such as in the metadata of the document or on the system.

The system and method described herein may provide automated classification of electronic documents. The automated document classification may expedite the data capture process by classifying documents in the queue much faster than normal manual processes.

The system may include a plurality of templates used to compare against electronic documents in a queue that are waiting to be classified and processed. Each template may include one or more objects associated with the template. The system may use image recognition to search the electronic documents in the queue to determine if the objects or images associated with a given profile are found within that document. If a match is found, the electronic document may be classified and associated with that template, and data may be extracted based on parameters defined within the template. In an embodiment, the system may determine that an electronic document matches the template when only one of a set of objects or images is found. Alternatively, the system may determine that a match exists when two or more images or objects associated with the template are matched on the document.

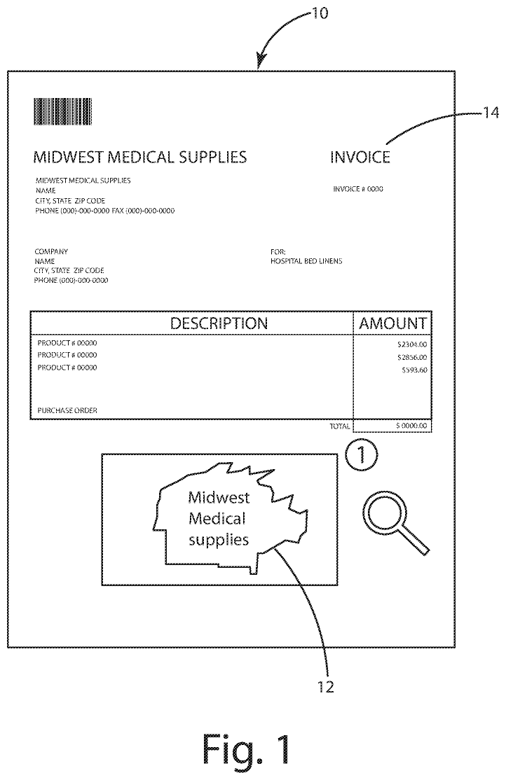

By way of illustrative example, an electronic document 10 is shown in FIG. 1. The electronic document 10 comprises an invoice from a company named Midwest Medical Supplies, which includes its logo 12 at some location on each of its invoices. All invoices from this company are also labeled with the word “invoice” 14 at some place on the page. The system may apply image recognition to the document to search for the logo 12 on the page and to search for the word “invoice” 14 as an object. If both are found, the system may indicate a match between the electronic document 10 and the template profile for Midwest Medical Supplies Invoices.

Once an electronic document 10 is classified, the system may then apply predefined rules associated with the template to capture data from the document. For example, the template profile may define an image or object to locate on the electronic document 10 that acts as an anchor 20. The anchor 20 may be any image or object that is located a distance from data to be captured by the system. The template may further define a distance from the anchor 20 where desired data is expected to be located. The system may apply OCR to a region of interest 22 a specified distance away from the anchor. Readable data that is recovered from the OCR process may then be extracted. The template may define what the data represents, such as invoice number, invoice amount, etc., for each data value extracted.

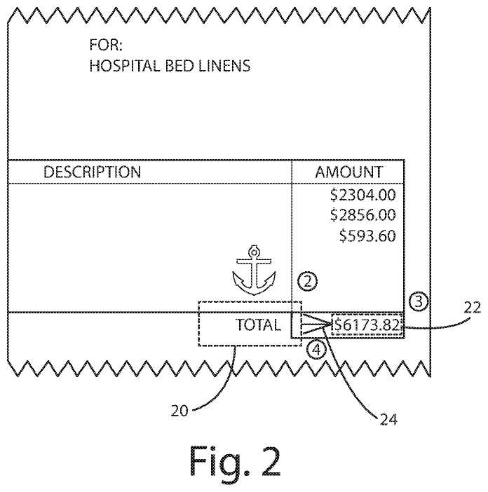

By way of illustrative example, FIG. 2 shows an anchor 20 defined around the word “total” shown on the electronic document 10. The template may instruct the system to OCR only a region of interest 22 that is located a predefined distance and direction 24 from the anchor 20. The OCR region of interest 22 may include the invoice total amount which is consistently located a fixed distance away from the word “total” on all invoices associated with the Midwest Medical Supplies Invoices template. Once OCR is performed on the region 22 the data may be received into the system and may be appended to the document as metadata or sent to other systems as defined within the template.

In an embodiment, the system may include a neural network. The neural network may be used separately or in conjunction with the template classification system set forth above.

The neural network may be trained to determine common features within a given document classification. For example, the neural network may analyze a large set of documents within a given classification to determine features that may be common to all documents within the classification. As additional documents are added within a classification, they may be used to further teach the neural network.

The system may utilize the neural network to analyze unclassified documents in the queue and predict a match or likelihood of a match with a given template. Specifically, the neural network may compare the common features within the classification to features of the electronic document to determine the likelihood of a match between the document and the classification. The likelihood may be computed as a percentage confidence level of a match between the electronic document and the classification.

The system may set a minimum confidence level threshold for a match between an electronic document and a given classification to filter out classifications that are not potential matches for a given electronic document. If an electronic document exceeds the threshold then the system may proceed to further evaluate a potential match between the electronic document and the template for that classification. However, if the electronic document does not exceed the minimum threshold for a classification then the classification may be eliminated as a potential match. Because the neural network processing is significantly faster than template comparison and analysis, utilizing the neural network as a filter for potential classification matches may substantially reduce the time it takes for the system to determine a match.

In an embodiment, electronic documents may be analyzed to determine classification based on a vector comparison. Documents within a given classification may be analyzed and a unique vector determined for each document. The vector may comprise a series of floating point numbers, wherein the numbers are numeric values assigned to learned attributes of the document. The learned attributes may include features such as the layout, shape, density, position and color of the document, and other similar features. The points may form a vector having a value and direction. Documents within a given classification will have vectors of similar characteristics based on their similar features and attributes. Unclassified documents may then be processed and assigned to a classification based on comparisons between an unclassified document vector and vectors of known documents within the class. For example, the system may determine the cosine between the unclassified document vector and the known vectors within the classification. However, it will be appreciated that other comparisons may be used as well. Threshold comparison levels may be used to determine if the comparison outcome meets the classification requirements. If the threshold requirements are met then the document may be assigned to the classification and assigned to an appropriate template for data to be extracted. If the document does not meet the threshold requirements then the unclassified document vector may be compared with document vectors within a new class, or may be passed through the neural network or template comparison, as set forth above.

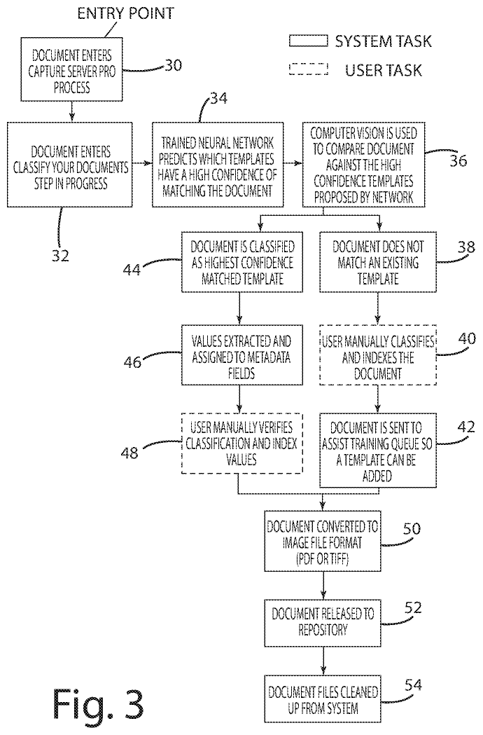

With reference to FIG. 3, a method of classifying an electronic document is generally provided. It will be appreciated that the method disclosed herein may include any of the steps shown or described in FIG. 3 or subsets of those steps, and arranged in any appropriate order. At a first step 30, an electronic document 10 may enter the system, such as through a network, and be loaded into a queue. In a second step 32, the document 10 may be routed to the classification system. In a third step 34, the electronic document 10 may be processed by the neural network to determine a confidence level for each available template. In the fourth step 36, the system may analyze any templates that have a confidence level above the minimum threshold and compare them with the electronic document 10. If no match is found between the electronic document 10 and an existing template, the system may move to steps 38-42 and place the document into a queue to be manually classified. The document may further be marked as requiring a new template to be added to the system. If a match is found between the electronic document 10 and a template, then the system may move to steps 44-48, where the document 10 may be classified and data extracted from the document and assigned to metadata fields of the document. A manual verification step 48 may optionally be added to verify classification. Once data is extracted, the electronic document 10 may be converted to an image file in step 50, such as a PDF or TIFF, and released to a document repository in step 52. The document files may then be cleaned or purged from the system.

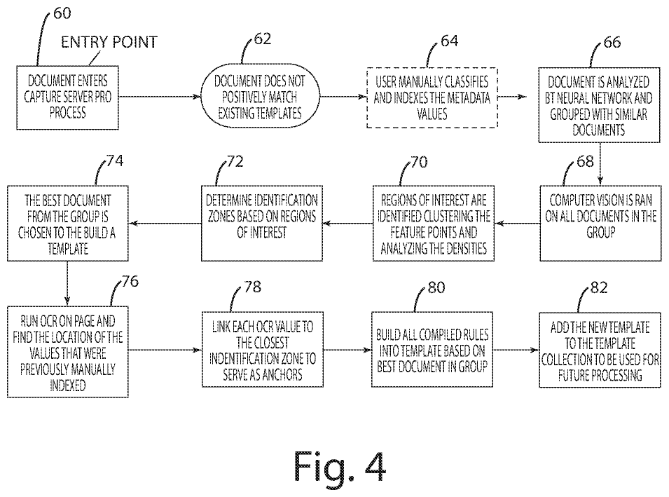

In an embodiment, the system may be configured to automate template creation when a matching template for a document is not found. With reference to FIG. 4, a method of creating a new template is generally provided. It will be appreciated that the method disclosed herein may include any of the steps shown or described in FIG. 4 or subsets of those steps, and arranged in any appropriate order. In a first step 60, an electronic document 10 may enter the classification system and may fail to match any existing templates 62. The electronic document 10 may then be manually classified and metadata of the document indexed and modified at the next step 64. The document may then be analyzed by the neural network 66 and grouped with similar documents, as appropriate. In the next step 68 computer vison may be run on the document 10 as well as any other similarly classified documents that have not been processed through the neural network. Regions of interest may then be identified 70 through analyzing densities and clustering. In the next step 72, identification zones may be determined based on the regions of interest. The system may then select the best document from the group to use for building a template 74. The system may OCR the entire document 10 to find locations of the data values that were previously manually indexed 76. Each data value may then be linked to the closest identification zone 78. The identification zones may serve as anchors for the respective closest data values. In step 80 the template may be built by compiling all rules applied to the document. The template may then be added to the template collection and used to process other electronic documents received into the system 82.

In an embodiment, the system may be configured to share templates between users. For example, some electronic documents, such as invoices from commonly used shipping companies, may be commonly processed by numerous companies. Users at a first company may opt into a sharing service that may share some or all templates in their system. Likewise, other users in the shared system will also share their templates to create a larger database of templates to compare against new electronic documents.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. A method of classifying electronic documents comprising:
providing one or more electronic documents to be sorted and classified, the one or more electronic documents each including data to be extracted;
comparing an electronic document from the one or more electronic documents to a template, wherein the template includes one or more objects to be compared to the electronic document and further wherein the template includes parameters that define data to be extracted from the document;
determining a match between the electronic document and the template based on the presence of one or more template objects in the electronic document;
extracting data from the electronic document based on template parameters; and
associating the extracted data with the electronic document.

2. The method of claim 1, wherein the template object includes a graphic image.

3. The method of claim 2, wherein the template includes a second object and wherein the second object comprises a text.

4. The method of claim 1 wherein the template parameters include an anchor object and a predefined location of a data to be extracted from the electronic document based on the location of the anchor object on the electronic document.

5. The method of claim 4 further comprising determining the location of the anchor object on the electronic document.

6. The method of claim 5 further comprising the step of locating the data to be extracted from the electronic document based on the location of the anchor in the electronic document.

7. A method of classifying electronic documents comprising:
training a neural network to determine common features within a document classification, wherein training comprises the steps of:
analyzing a set of electronic documents within a common classification;
determining common features between the set of electronic documents within the common classification;
providing one or more electronic documents to be sorted and classified, the one or more electronic documents each including data to be extracted;
comparing an electronic document from the one or more electronic documents to the common features within a given classification;
determining a match between the electronic document and the classification based on similarities between the electronic document and the common features;
extracting data from the electronic document based on parameters associated with the classification; and
associating the extracted data with the electronic document.

8. The method of claim 7 further comprising, in the event of no classification match determined by the neural network, comparing the electronic document from the one or more electronic documents to a template, wherein the template includes one or more objects to be compared to the electronic document and further wherein the template includes parameters that define data to be extracted from the document.

9. The method of claim 8 wherein the template parameters include an anchor object and a predefined location of a data to be extracted from the electronic document based on the location of the anchor object on the electronic document.

10. The method of claim 9 further comprising determining the location of the anchor object on the electronic document.

11. The method of claim 10 further comprising the step of locating the data to be extracted from the electronic document based on the location of the anchor in the electronic document.

12. A method of classifying electronic documents comprising:
providing a set of electronic documents in a common classification, wherein the classification includes parameters for determining data within each document to be extracted;
determining a unique vector for each document in the set of commonly classified electronic documents, wherein the vector for each classified document is determined by assigning numeric values to attributes of the document;
determining a vector value for an unclassified document, wherein the vector value is determined by assigning numeric values to attributes of the unclassified document
comparing the vector value of the unclassified document to vector values of the classified documents;
determining the presence of a match between the unclassified document and the classified documents based on a predetermined threshold level;
extracting data from the electronic document based on parameters associated with the classification; and
associating the extracted data with the electronic document.

13. The method of claim 12, wherein the comparison of the unclassified document vector to classified document vector values includes determining a cosine of the unclassified document vector and the classified document vectors.

14. The method of claim 13 further comprising, in the event of no classification match determined by the vector comparison, comparing the electronic document from the one or more electronic documents to a template, wherein the template includes one or more objects to be compared to the electronic document and further wherein the template includes parameters that define data to be extracted from the document.

15. The method of claim 14 wherein the template parameters include an anchor object and a predefined location of a data to be extracted from the electronic document based on the location of the anchor object on the electronic document.

16. The method of claim 15 further comprising determining the location of the anchor object on the electronic document.

17. The method of claim 16 further comprising the step of locating the data to be extracted from the electronic document based on the location of the anchor in the electronic document.
